(19) United States
(12) Patent Application Publication
(10) Pub. No.: US 2002/0002608 A1
(43) Pub. Date: Jan. 3, 2002

(54) NETWORK DEVICE MANAGEMENT SYSTEM

(76) Inventors: BILL JOHN ASPROMONTE, SANTA CRUZ, CA (US); JEFFREY RUSSELL SPRAGUE, SAN JOSE, CA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/218,757

(22) Filed: Dec. 22, 1998

(51) Int. Cl. G06F 15/173

(52) U.S. Cl. 709/223

(57) ABSTRACT

A network management system is provided for communicating network management information between a managing network device and a managed network device interconnected by a network devices. The network management system includes a manager for monitoring and managing network management information across the network, where the manager resides on the managing network device, and a management module for responding to requests for network management information from the manager, where the management agent resides on the managed network device. A first application registers at least one function with the management module, whereby the function provides access to network management information associated with said first application. In response to a request from the manager, the management module through the use of the function is capable of providing the manager access to network management information associated with the first application.

### BACKGROUND OF THE INVENTION

The present invention relates generally to a network device residing on a network in a multimedia delivery system, and more particularly to a network management system for communicating network management information between at least two network devices interconnected by a network.

The Federal Communications Commission (FCC) has promulgated a new set of television broadcasting standards for implementing digital television (DTV). It is expected that digital television will eventually replace the current NTSC standard in homes across the country and throughout the world. Digital TV offers a number of advantages over the conventional NTSC standard, including high-definition pictures, vastly improved user interactivity, support for Internet email resources and the like.

We anticipate that the new digital TV standard will promote the confluence of computer and television technologies with far reaching impact. Thus, the personal computer will someday function as home entertainment multimedia system and the television will function as a node on a variety of computer networks ranging from the home automation network to the Internet. While there are a number of different possible physical packages for deploying digital television technology, currently most popular is the set-top box.

In the early days, the set-top box served primarily as the tuner and signal descrambler for cable TV. More recently, companies such as Scientific Atlanta have developed far more sophisticated set-top boxes. Interactive digital set-top boxes provide an open platform for developing and delivering interactive services and multimedia content to consumers across a broadcast network. To provide the power of the personal computer, these sophisticated set-top boxes incorporate a full-fledged computer operating system. Requirements such as management of high data throughput, effective management of memory in a constrained consumer device, and support for a secure environment drive the decision to architect an innovative operating system for use in set-top boxes.

However, the set-top box offers a challenging site to deploy a computer operating system. Unlike operating systems for general purpose computers, the operating system in the set-top box cannot always be rebooted when a software problem occurs. TV viewers find it highly unacceptable when forced to reboot while watching a favorite program. In other instances, rebooting the operating system may not resolve the software problem and it becomes necessary for the cable operator to dispatch a repair person to fix the problem.

A network management system is commonly used to monitor and manage the different types of network devices residing on a computer network. Typically, a managing network device serves as an interface tool to each of the managed network devices. Each of the managed network devices includes a management agent that responds to requests for network management information from the managing network device. Simple Network Management Protocol (SNMP) is a well known network communication protocol for managing communication between network devices residing on a TCP/IP-based network.

Although network management systems have been in operation for a long time, these system have only focused on simple, single function network devices (e.g., switches, routers, etc.). As a result, the management agent merely hard-codes each of the functions needed to support a request from the managing network device. However, due to memory constraints in the set-top box environment, the management agent of the present invention cannot hard-code all of the functions needed to support the various application associated with the complex set-top box environment.

Therefore, it is desirable to provide a robust management agent that is integrated into the operating system residing on the set-top box. The management agent of the present invention provides a plurality of internal functions for managing the architecture-independent aspects of the set-top box. Moreover, the management agent supports the dynamic installation of application-specific functions which allows a cable operator to remotely troubleshoot software problems that may occur at the application level of a set-top box.

### SUMMARY OF THE INVENTION

In accordance with the teachings of the present invention, a network management system is provided for communicating network management information between a managing network device and a managed network device interconnected by a network devices. The network management system includes a manager for monitoring and managing network management information across the network, where the manager resides on the managing network device, and a management module for responding to requests for network management information from the manager, where the management agent resides on the managed network device. A first application registers at least one function with the management module, whereby the function provides access to network management information associated with said first application. In response to a request from the manager, the management module through the use of the function is capable of providing the manager access to network management information associated with the first application.

### BRIEF DESCRIPTION OF THE DRAWINGS

FIG. 1 is a diagram showing the components of a conventional network management system;

FIG. 2 is a block diagram illustrating the basic software components for an operating system in accordance with the present invention;

FIG. 3 is a diagram showing a management agent residing on a managed network device in accordance with the present invention;

FIG. 4 is a diagram showing a preferred embodiment of a management agent in accordance with the present invention;

FIG. 5 is tree diagram showing the MIB II groups supported by the present invention;

FIG. 6 is a tree diagram showing the private enterprise subtree in accordance with the present invention; and

FIG. 7 is a diagram showing how the management agent of the present invention supports raising application-specific alarms at the managing network device.

### DETAILED DESCRIPTION OF THE PREFERRED EMBODIMENT

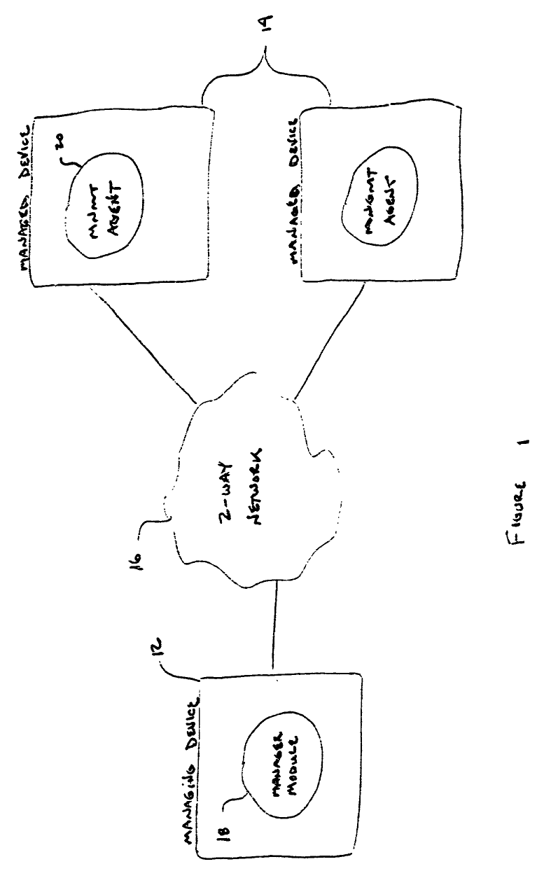

A network management system 10 for communicating network management information between at least two network devices is depicted in FIG. 1. The network management system 10 includes a managing network device 12 and a plurality of managed network devices 14 interconnected by a two-way network 16. Simple Network Management Protocol (SNMP) is a well known TCP/IP-based protocol for managing communication between network devices. While the following description is provided with reference to SNMP, it is readily understood that the explanation is applicable to other network management protocols.

In the context of the SNMP model, a network manager module 18 residing on the managing network device 12 serves as an interface tool which monitors and manages the managed network devices 14. The network manager module 18 can either retrieve or set the values of network management information residing on one of the managed network devices 14. A managed network device 14 includes a management agent 20 that responds to requests for access to network management information from the network manager module 18. As will be more fully explained, the management agent 20 of the present invention is preferably embedded as a software component in the operating system residing on a set-top box.

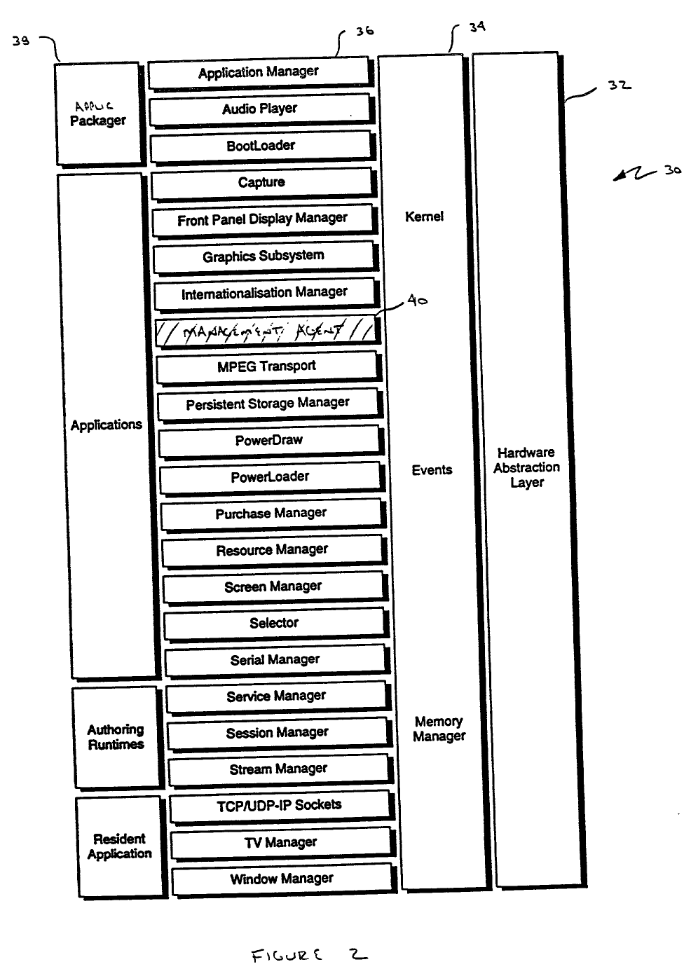

Accordingly, FIG. 2 illustrates the basic software components of an operating system 30 for use in a set-top box. The multitasking operating system 30 is designed to address the high-performance demands of media-centric, real-time applications being delivered through a set-top box. The operating system 30 provides an open, scalable platform for developing and delivering multimedia content to consumers across broadcast and client/server networks. The software architecture for the operating system 30 is comprised from layers of interconnected software modules designed to minimize redundancy and optimize multimedia processing in an interactive, network setting. The layers of the architecture include a hardware abstraction layer 32, a core layer 34, an application support layer 36 and an application layer 38.

Each hardware device associated with the set-top box is abstracted into a software device module that resides in the hardware abstraction layer 32. Each of these software device modules are responsible for media delivery and manipulation between a hardware device and the remainder of the operating system, thereby separating the hardware dependencies of each device from the portable operating system facilities and masking the idiosyncrasies of different hardware implementations.

A kernel and memory manager residing in the core layer 34 provide the base functionality needed to support an application. A fully preemptive, multithreaded, multitasking kernel is designed to optimize both set-top memory footprint and processing speed. Since the operating system will reside on consumer units, it has been designed to exist in a ROM-based system with a very small footprint (e.g., 1 MB). In addition, the kernel has also been created to take advantage of 32-bit Reduced Instruction Set Computer (RISC) processors which enable high-speed transmission, manipulation and display of complex media types. The memory manager provides an efficient allocation scheme to enable the best performance from limited memory resources. Because embedded processors are likely to be the mainstay of consumer digital hardware implementations, the memory model requires little memory management unit support. The core layer 34 also provides an integrated event system and a standard set of ANSI C utility functions.

Built on top of the core layer 34 is an application support layer 36. This set of support modules provides higher-level processing functions and application services. Application management, session management, and tuner management are a few examples of these services. In accordance with the present invention, the management agent 20 resides within the application support layer 36 of the operating system 10. Lastly, the application layer 38 contains a set of applications that are supported by the remainder of the operating system 10.

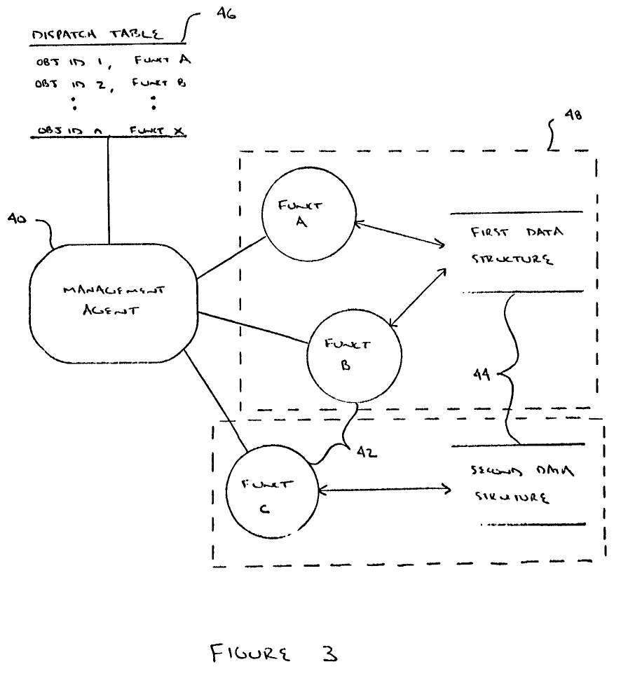

Implementation of a management agent 40 in accordance with the present invention will be discussed in relation to FIG. 3. In order to respond to a request from the managing network device, the management agent 40 supports a plurality of predefined internal functions. Each function is responsible for accessing some portion of the configuration, status, and statistical information (herein referred to as “network management information”) associated with the managed network device 14. In particular, these functions are used to retrieve and/or update network management information which is stored in various physical data structures 44 associated with the managed network device 14.

An object identifier is a string of numbers sent by the managing network device to identify a particular predefined function. In accordance with ISO/CCITT standards, the object identifier is derived from a global naming tree as will be more fully described below. Upon receiving an object identifier, the management agent 40 looks up the object identifier in an internal dispatch table 46. The dispatch table 46 maps the object identifier to one of the plurality of predefined functions 42 associated with the management agent 40. Next, the management agent 40 calls the corresponding internal function to perform the requested network management operation (e.g., retrieve the number of incoming bytes received at an interface or the IP address assigned to an interface). In this case of a retrieval operation, the requested network management information is passed back from the function 42 to the management agent 40 which in turn supplies the information via the network to the managing network device.

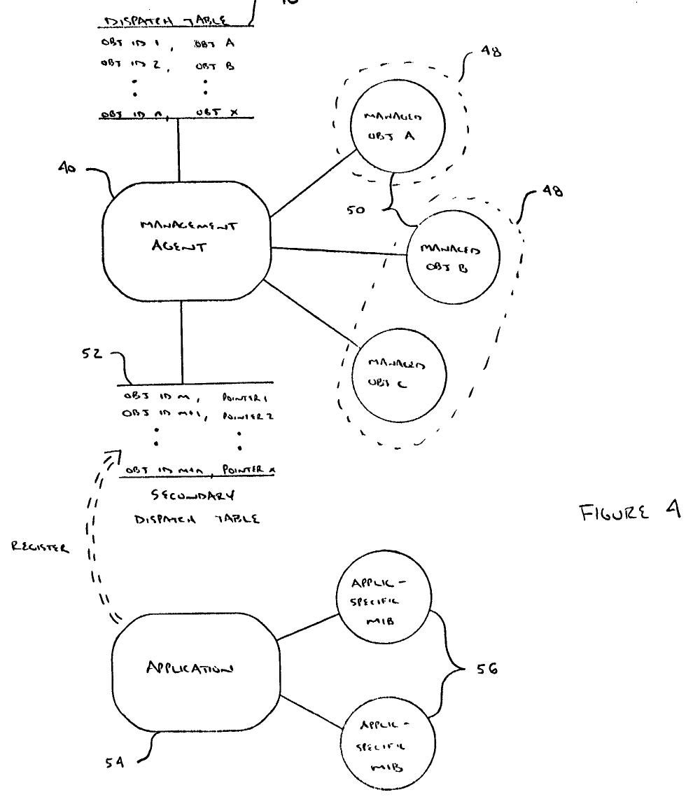

The logical data structure used to store network management information on a managed network device is commonly referred to as a Management Information Base (MIB). In FIG. 3, a MIB 48 is comprised of one or more predefined functions 42 and their corresponding physical data structure 44. In contrast, a MIB 48 may also be embodied as a collection of managed objects 50 which are directly accessed by the management agent 40 as shown in FIG. 4. Each managed object 48 is derived from a managed object superclass through instantiation, such that the managed objects have attributes for storing network management data and methods for processing stored network management data. For purposes of the following description, a MIB is defined as the means for accessing as well as the data structure for storing network management information on a managed network device.

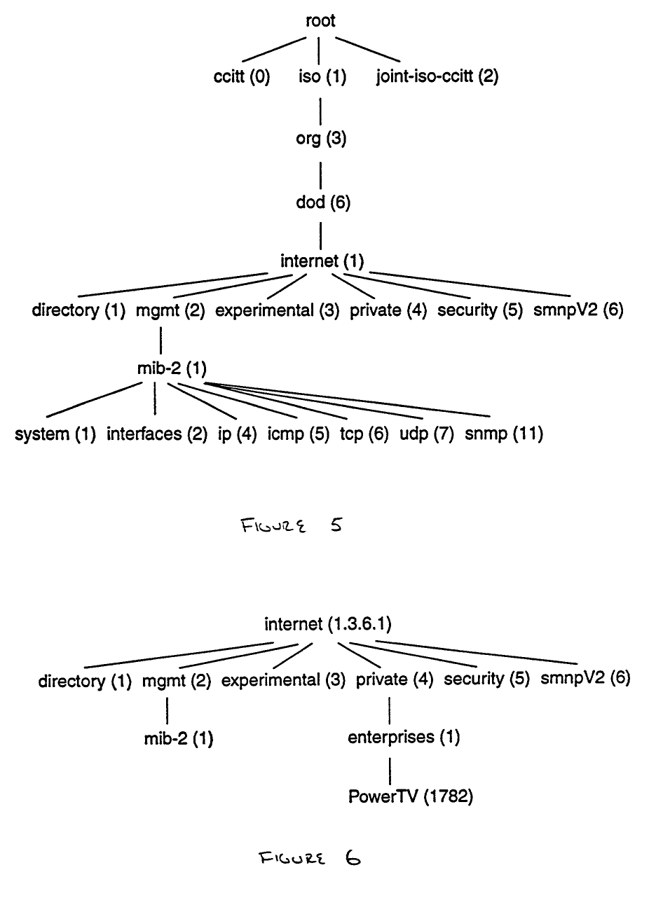

MIBs are generally standardized across a class of devices in accordance with SNMP. One skilled in the art will readily recognize that within the global naming tree, the MIB II subtree (i.e., 1.3.6.1.2.1) contains the groups of objects for managing the architecture-independent aspects of set-top boxes. FIG. 5 shows the MIB II groups supported by the management agent 40 of the present invention, including the System group (system:1), Interfaces group (interfaces:2), Internet Protocol group (ip:4), Internet Control Message Protocol group (icmp:5), Transmission Control Protocol group (tcp:6), User Datagram Protocol group (udp:7), and SNMP Application Entity group (snmp:11). Although it is envisioned that the management agent 40 could support them, it does not currently support the Address Translation group (at:3) or the Media-specific group (transmission:10) which are both obsolete, or the Exterior Gateway Protocol group (egp:8) because the set-top box is not a gateway.

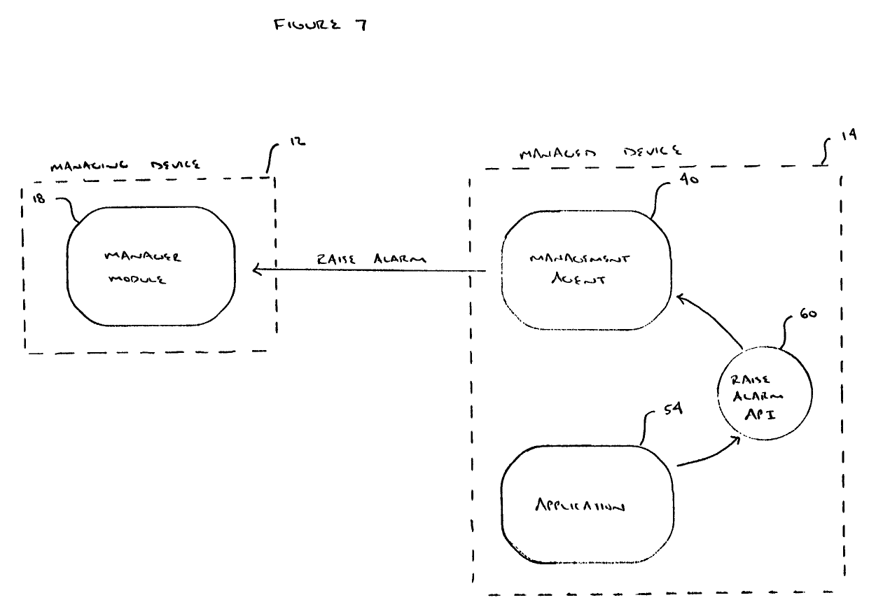

A private enterprise subtree enables one to define custom MIBs related to their products. As shown in FIG. 6, the assignee of the present invention was assigned the private enterprise number (i.e., 1782) by the Internet Assigned Numbers Authority. In this way, the management agent 40 of the present invention provides additional access to set-top related information through the use of custom MIBs.

Moreover, the management agent 40 of the present invention also provides a mechanism for accessing application-specific diagnostic information. As will be apparent to one skilled in the art, application-specific diagnostic information varies from the typical architecture-independent set-top related information. Moreover, application-specific diagnostic information will vary between applications. Therefore, the management agent 40 of the present invention supports application-specific MIBs that are dynamically installable by each application.

Returning to FIG. 4, a secondary dispatch table 52 is used to maintain a list of available application-specific MIBs. An application 54 registers an application-specific MIB 56 with the management agent 40 by placing an entry into the secondary dispatch table 52. The management agent 40 provides an API (i.e., snmp_install) that allows an application to interface with the secondary dispatch table 52. The secondary dispatch table 52 in turn maps an object identifier to a pointer (i.e., memory address) for the corresponding application-specific MIB 56, thereby providing a link between the management agent 40 and the requesting application 52. In the preferred case, the application-specific MIB 56 is defined as an internal function of the requesting application 54, but may also be implemented as one or more managed objects that are associated with the requesting application.

Upon receiving an object identifier, the management agent 40 looks for a match in the primary dispatch table 46. If found, the management agent 40 proceeds as previously described. However, if the object identifier is not found on its primary dispatch table 46, then the management agent 40 searches the secondary dispatch table 50. If a match is found, the corresponding pointer value is used to call the appropriate application-specific MIB 56. The requested network management information is then passed back from the application-specific MIB 56 to the management agent 40 which in turn supplies the information via the network to the managing network device. It should be noted that application-specific MIBs are merely custom MIBs that are defined by the application developers. From the viewpoint of the managing network device, a dynamically installed MIB behaves in the same manner as a traditionally hard-coded embedded MIBs. It is also envisioned that custom MIBs may also be dynamically installed by device drivers residing on the managed network device. By allowing the application to install its own MIB handlers, memory space is saved in the operating system and it is not necessary to reconstruct and release a new version of the operating system whenever an application developer (or custom) wants to add a new MIB. This is particularly useful when debugging the software or performing system integration on the set-top box.

Alarms (or “traps”) are a feature of SNMP that allows a management agent to initiate communication with the managing network device if a certain error condition arises in the managed network device. In FIG. 7, the management agent 40 of the present invention supports an API 60 (i.e., snmp_sendtrap) that allows an application 54 to raise an application-specific alarm at the managing network device 12. An application 54 calls the API 60 which in turn accepts a string of text that describes the application-specific error condition. An example of such an alarm might be a password failure message that is invoked after the application 54 detects multiple entries of an incorrect password. In this case, the alarm may alert a cable operator of a potential unauthorized user. Next, the management agent 40 communicates the message across the network. Lastly, the application-specific alarm and its corresponding text message appear on the manager module 18 at managing network device 12.

The foregoing discloses and describes merely exemplary embodiments of the present invention. While depicting a management agent 20 designed to reside on a conventional set-top box, the following description is intended to adequately teach one skilled in the art to make and use a management agent for a variety of consumer multimedia clients including, but not limited to, intelligent televisions, Internet terminals and advanced DVD players. One skilled in the art will readily recognize from such discussion, and from the accompanying drawings and claims, that various changes, modifications and variations can be made therein without departing from the spirit and scope of the present invention.

What is claimed is:

1. A network management system for communicating network management information between at least two network devices interconnected by a network; comprising:
a manager residing on a managing network device for monitoring and managing network management information across the network;
a management module residing on a managed network device for responding to requests for network management information from said manager;
an application residing on said managed network device for registering at least one function with said management module, whereby said function provides access to network management information associated with said first application; and
said management module being operative, in response to a request from said manager, to provide said manager access to network management information associated with said first application.

2. The network management system of claim 1 further comprising a secondary dispatch table associated with said management module, whereby said application registers said function in said secondary dispatch table to establish a link between said function and said management module.

3. The network management system of claim 1 wherein said management module having a plurality of internal functions that provide access to network management information available to said management module, and being operative, in response to a request from said manager, to use of said internal function to provide said manager access to network management information available to said management module.

4. The network management system of claim 1 further comprising a managed object associated with said management module to provide access to network management information, whereby said managed object being derived through instantiation from a common managed object superclass such that said managed object having attributes for storing network management information and methods for processing stored network management information.

5. The network management system of claim 1 wherein said first application being further defined as a device driver module.

6. The network management system of claim 1 wherein said managed network device being further defined as a set-top box.

7. The network management system of claim 1 wherein the network management system employs Simple Network Management Protocol (SNMP) for session management across the network.

8. A network management system for communicating network management information between a managing network device and a managed network device interconnected by a network; comprising:
a manager residing on the managing network device for monitoring and managing network management information across the network;
a management module residing on the managed network device for responding to requests for network management information from said manager, said management module having a plurality of internal functions that provide access to network management information available to said management module;
a secondary dispatch table associated with said management module for establishing a link between a plurality of application-specific functions and said management module;
an application residing on the managed network device for registering at least one application-specific function in said secondary dispatch table, whereby said application-specific function provides access to network management information available to said application; and
said management module being operative, in response to a request from said manager, to call at least one of said plurality of internal functions and said plurality of application-specific functions, thereby providing said manager module access to network management information.

9. The network management system of claim 8 wherein said secondary dispatch table provides a pointer to each of the application-specific functions registered in said secondary dispatch table.

9. The network management system of claim 8 wherein said managed network device being further defined as a set-top box.

10. The network management system of claim 8 wherein said first application being further defined as a device driver module.

11. The network management system of claim 8 wherein the network management system employs Simple Network Management Protocol (SNMP) for session management across the network.

12. A method for communicating network management information between at least two network devices interconnected by a network, comprising the steps of:
providing a manager module for monitoring and managing network management information across the network, said manager module residing on a managing network device;
providing a management agent for responding to requests for network management information from said manager module, said management agent residing on a managed network device;
registering a function with said management agent by an application residing on said managed network device, whereby said function being associated with said application to provide access to network management information associated with said first application;
receiving a request at said management agent to access network management information associated with said application; and
responding to said request through the use of said function by said management agent, thereby providing said manager module access to network management information associated with said first application.

13. The method of claim 12 wherein the step of registering a function further comprises using a secondary dispatch table to establish a link between said function and said management agent.

14. The method of claim 12 further comprises using a set-top box as said managed network device.

15. The method of claim 12 further comprises using a device driver module as said application.

16. The method of claim 12 further comprises using Simple Network Management Protocol (SNMP) for session management across the network.

17. A method for communicating network management information between a managed network device and a managing network device interconnected by a network, comprising the steps of:
providing a manager module for monitoring and managing network management information across the network, said manager module residing on the managing network device;
providing a management agent for responding to requests for network management information from said manager module, said management agent residing on the managed network device;
registering a function with said management agent by an application residing on the managed network device, whereby said function being associated with said application to provide access to network management information available to said first application;
receiving a request to access network management information;
searching for said request in a primary dispatch table associated with said management agent;
responding to said request when said request being found in said primary dispatch table, thereby providing said manager module access to network management information available to said management agent;
searching for said request in a secondary dispatch table when said request not found in said primary dispatch table, said secondary dispatch table being associated with said management agent to establish a link between said function and said management agent; and
responding to said request through the use of said function when said request corresponds to said function in said secondary dispatch table, thereby providing said manager module access to network management information available to said application.

18. The method of claim 17 wherein the step of responding to said request through the use of said function further comprises using a pointer in said secondary dispatch table to call said function.

19. The method of claim 17 wherein the step of responding to said request when said request being found in said primary dispatch table further comprises using an internal function associated with said management agent to access network management information.

20. The method of claim 17 wherein the step of responding to said request when said request being found in said dispatch table further comprises using a managed object associated with said management agent to access network management information, whereby said managed object being derived through instantiation from a common managed object superclass such that said common objects have attributes for storing network management information and have methods for processing stored network management information.

21. The method of claim 17 further comprises using a set-top box as said managed network device.

22. The method of claim 17 further comprises using a device driver module as said application.

23. The method of claim 17 further comprises using Simple Network Management Protocol (SNMP) for session management across the network.
